(19) United States
(12) Patent Application Publication
(10) Pub. No.: US 2007/0031199 A1
(43) Pub. Date: Feb. 8, 2007

(54) Rotary tool

(76) Inventor: Andrew M. Kvalheim, Petaluma, CA (US)

Correspondence Address: Corwin R. Horton, The Park, Suite 2001, 25 Mann Drive, Kentfield, CA, 94904, US

(21) Appl. No.: 11/196,201

(22) Filed: Aug. 3, 2005

(51) Int. Cl. B23C 5/02

(52) U.S. Cl. 407/31

(57) ABSTRACT

A rotary tool capable of employing one of two tool implements, alternatively, and capable of shifting between the two implements semi-automatically. A rotatable mandrel carries a first tool implement and a carriage is mounted on the mandrel to rotate around the same axis and carries a second implement. The carriage is moveable axially relative to the mandrel between a rearward position where the second implement is inactive and the first implement is at an advanced active position and a forward position where the second implement is at an advanced active and the first implement is at a retracted inactive position. An interlock device is provided for the mandrel and carriage that stops axial movement of the carriage beyond the forward position and stops rotational movement between the mandrel and the carriage while the carriage is at the forward position.

### BACKGROUND OF THE INVENTION

This invention relates to rotary tools and particularly to tools rotating about an axis having at an axial end thereof a device for carrying out a desired mechanical function. These include tools for milling, drilling, sawing, screw or bolt driving or removal and other mechanical operations requiring a rotary tool. Such tools typically comprise a mandrel or arbor having at its working end an implement that carries out its mechanical function upon rotation of the shaft. Usually the rotary tool is powered by a rotary electrical motor having a clamping device at the terminal end of its arbor, termed a chuck, for griping the shank end of the tool and rotating the tool coaxially with the arbor. These tools normally have a single bit or other functional implement at the working end thereof for carrying out the mechanical function upon rotation of the tool. To change the size or other characteristic of the tool, it is necessary to either replace the functional implement or the entire tool, This requires dismount and of the implement or the entire tool from the motor and replacement. Substantial operator intervention and downtime thus results.

Shapers and routers are important examples of such rotary tools which are employed to mill various substrates, including wood and metal workpieces. They typically comprise a revolving spindle with a cutter at its front end and a motor connected to the other end of the spindle to rotate it. They are used for milling at the surface of both metal and wood, for example cutting hinge pockets, latch pockets and bore holes for door bolts in the manufacture of “prehung” doors with associated doorjambs. In this application it is frequently necessary in the middle of an operation to substitute a cutter blade of different diameter or type. This requires dismounting the spindle from the motor connection resulting in downtime and additional operator time.

U.S. Pat. No. 6,561,238 describes a cutting tool that may be used for both routing and boring applications on a wooden door. A first bit is mounted at the forward end of a spindle of a rotary tool for rotation with the spindle. This bit may be used for routing to the depth of this bit for forming latch pockets in the door. Behind the first bit and fixed thereto is a second bit mounted for rotation with the spindle. The second bit is of a larger diameter for drilling a latch or lock bore in the door to a substantially greater depth. This arrangement permits the tool to carry out two different operations without having to change bits. However, neither bit can operate independently of the other. Nor is this arrangement capable of carrying out other tool operations.

U.S. Pat. No. 6,676,340 describes rotating tool for surface machining of a workpiece having cutting edges extending from the tool body axially forward of the working tool end face thereof. The tool body is provided with deburring devices each containing a wire brush that is retractable to a storage position within the tool body and extendable to an active position forward of the working tool end face to deburr the face of the workpiece being machined by the cutting edges of the tool. A piston in each deburring device to move the wire brush between the retracted position and the extended active position. In the extended position the deburring wire brush extends forward of the tool end face to or beyond the tips. The cutter tips may also be moved in the axial direction to a greater or lesser extent beyond the working end face of the tool. Movement in the axial direction of either the cutter tips or the brushes requires an actuating force and either a pressurized fluid or an electromechanical force is proposed. For this a pressurized fluid or electrical feed to the rotating tool must be supplied from outside of the rotating tool through a hollow fastening shank into the tool body. This approach is complex, costly and increases the bulk of the tool.

### SUMMARY OF THE INVENTION

This invention relates to rotary tools and particularly to tools capable of employing one of two tool implements, alternatively, and capable of shifting between the two implements semi-automatically, with only simple and rapid manual procedures required, or fully automatically.

In this invention a rotatable mandrel carries one tool implement and a carriage is mounted on the mandrel to rotate around the same axis and carry a second implement. The carriage is moveable axially relative to the mandrel between a rearward position where the second implement is inactive and the first implement is at an advanced active position and a forward position where the second implement is at an advanced active and the first implement is at a retracted inactive position.

In a particular feature of this invention when the carriage is moved to the forward position the mandrel drives rotation of the carriage and the second implement carried by the carriage. For this purpose an interlock device is provided for the mandrel and carriage that releasably holds the carriage at the forward position and stops rotational movement between the mandrel and the carriage while the carriage is at the forward position. The interlocking device may be actuated when the carriage is at its forward position to prevent the carriage from moving to the other end of the path until it is desired to switch implements. The carriage may be moved back to the rearward position after releasing the interlocking device.

In another feature of the invention a detent is provided for the carriage to maintain the carriage at its rearward position while the mandrel is rotated for using the implement carried by the mandrel. Particularly advantageous is a magnet placed at the rearward end of the carriage that during rotation of the mandrel both holds against the carriage on its forward side and against a collet on the shank end of the mandrel or the chuck of the motor on its rearward side to prevent forward movement of the carriage.

Another feature is a binary tool having a carriage mounted on a mandrel in which the carriage is slidable between a rearward position, at which a first implement mounted on the forward end of the mandrel is in an advanced active position, and a forward position at which a second implement, at the forward end of the carriage, is in an advanced active position. An interlocking device for the mandrel and carriage is provided to releasably hold the carriage at the forward position and stop relativel rotational movement between the mandrel and the carriage while the carriage is at the forward position.

As another feature of the invention movement of the carriage between the active and inactive positions may be effected partially or completely by use of an externally threaded section on the mandrel meshing with an internally threaded sleeve on the carriage. In one such embodiment the threaded section extends partially along the mandrel in the forward direction of the carriage from an intermediate point. The carriage is sidable from the rearward position to where the threaded section of the mandrel is first engaged by the threaded sleeve on the carriage. The carriage may then be rotated relative to the carriage to screw the carriage the remaining way to the forward position.

In another such embodiment the threaded section on the mandrel extends along the mandrel over a distance to permit the carriage to be screwed completely between the forward and rear position. In this embodiment, a reversible rotation motor may be employed for driving the mandrel so that carriage may be urged in either direction, simply by reversing the direction of rotation. If the friction between the mandrel and the carriage is low enough and the inertia of the carriage is great enough, the carriage may thus be screwed by the reversible motor fully between the active and inactive positions However, as an additional feature in case the inertia of the carriage is too small to engender relative rotational movement between the carriage and the mandrel, friction may be applied to the carriage, either mechanically or manually to impede its rotation to permit the rotating mandrel to screw the carriage between the active and inactive positions.

As another feature in the foregoing screw-driven embodiments, a stop is provided that is operative, when the mandrel is rotated in the direction to move the carriage toward the forward position, to stop the carriage at the forward position and to stop relative axial rotational movement between the carriage and mandrel when the mandrel continues to rotate in that direction.

This invention is useful for a wide variety of tool implements and effect their mechanical functions by rotation, However it is particularly advantageous for shapers and routers, as for example, routers employed in preparing “prehung” doors where several different router bits are required.

### BRIEF DESCRIPTION OF THE DRAWINGS

FIG. 1 is an isometric view of an embodiment of the rotary tool of the present invention, taken from the forward end of the tool, with the carriage in its rearward position and showing the outer cylindrical section of the carriage as semi-transparent to facilitate viewing of the underlying structure;

FIG. 2 is a side view of the tool of FIG. 1;

FIG. 3 is an exploded view of the tool as shown in FIG. 2, showing the major components separately;

FIG. 4 is the same isometric view as in FIG. 1 of the tool of FIGS. 1, 2 and 3 but with the carriage at its forward position;

FIG. 5 is a side view as in FIG. 2 of the tool of FIG. 1 but with the carriage at its forward position;

FIG. 6 is a is an isometric view of the tool of FIGS. 1 through 5 mounted in the chuck of a rotary motor;

FIG. 7 is an isometric view of another embodiment of the rotary tool of the present invention, taken from the forward end of the tool, with the carriage in its forward position and showing the outer cylindrical section of the carriage as semi-transparent to facilitate viewing of the underlying structure;

FIG. 8 is the same isometric view as in FIG. 7 of the tool of FIG. 7 but with the carriage at its rearward position;

FIG. 9 is an exploded view of the tool as shown in FIGS. 7 and 8, showing the major components separately;

FIG. 10 is an isometric view as in FIG. 7 of the tool of FIG. 7 but showing an alternative interlocking device;

FIG. 11 is the same isometric view as in FIG. 10 of the tool of FIG. 10 but with the carriage at its rearward position;

FIG. 12 is an exploded view of the tool as shown in FIGS. 7 and 8, showing the major components separately;

FIG. 13 is an isometric view of yet another embodiment of the rotary tool of the present invention, taken from the forward end of the tool, with the carriage in its forward position and showing the outer cylindrical section of the carriage as semi-transparent to facilitate viewing of the underlying structure;

FIG. 14 is the same isometric view as in FIG. 13 of the tool of FIG. 13 but with the carriage at its rearward position;

FIG. 15 is an exploded view of the tool as shown in FIGS. 13 and 14, showing the various components separately; including the collet; and

FIG. 16 is an isometric view of the tool of FIGS. 13 and 14 mounted in the chuck of a two-way rotary motor having a brake system for the tool carriage.

### DETAILED DESCRIPTION OF THE PREFERRED EMBODIMENT

The following description illustrates the manner in which the principles of the invention are applied but is not to be construed as limiting the scope of the invention.

Binary rotary tools of this invention are intended for all applications where more than one tool implement may be required. These include tools for milling, drilling, sawing, screw or bolt driving or removal and other mechanical operations requiring a rotary tool. These tools may include a pair of the same type of implements, e.g. a pair of mining implements, each of a different diameter. Or, as appropriate, the tool may have diverse types of implements e.g. a drilling implement and a milling or screwdriving implement.

Embodiments of the invention include binary tools that may change from one implement to the other automatically and others that are changed semi-automatically. Both automatic and semi-automatic embodiments will be illustrated.

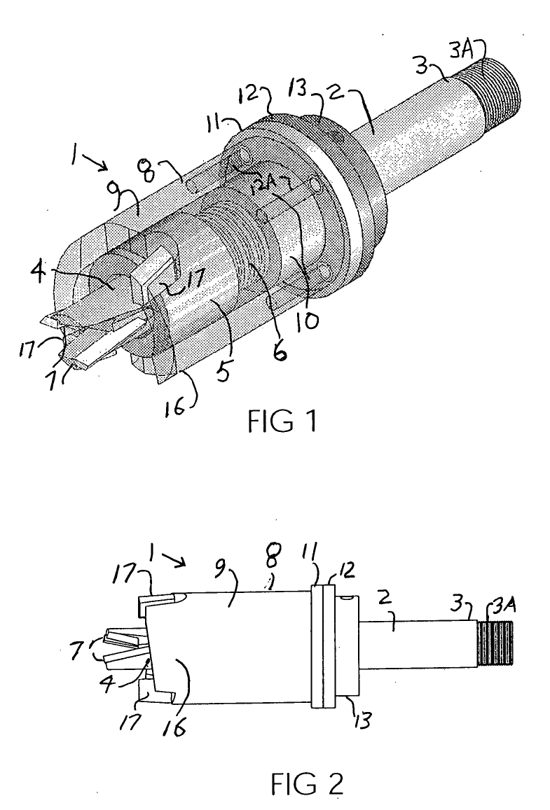

Semi-automatic changeover binary tools may be particularly adapted for use with motors that are capable of rotating only in a single direction. Referring to the drawings, particularly to FIGS. 1, through 6, a semi-automatic changeover binary tool 1 is shown having a mandrel 2 with a shank end 3 at its back for engagement in the chuck of motor arbor (not shown). Shank end 3 is threaded to receive a collet retaining nut as will be described.

At the front (working) end of mandrel 2 is a milling implement 4 comprising a forked cutting head. Implement 4 may be secured to the forward end of mandrel (2 by a screw, as will be described at a later point. A brass bushing 5 is shrunk fit on a section of mandrel 2. Immediately to the rear of implement 4 mandrel 2 has an externally threaded portion 6 with left-handed threads that extends rearward along mandrel 2 for a distance but leaving an unthreaded portion to shank 3.

Implement 4 has a pair of cutting bits 7 to provide an effective cutting diameter of ½ inch. Typical for this type of router head, implement 4 cuts primarily sideways rather than in the axial direction of the mandrel. Bits 7 are designed to cut in counter-clockwise rotation, looking from in front of implement 4.

Extending around mandrel 2 is a carriage 8 which is movable along the axial direction of mandrel 2 and rotatable about the mandrel along the same axis, as will be discussed. Carriage 8 has an outer brass cylindrical section 9 sized so that it may be received on mandrel 2 and over bushing 5 and an inner smaller diameter cylindrical section 10 toward the rear of carriage 8 enclosed by section 9. Section 10 has an integral flange 11 at its rearward end. A flange 12 of a magnetizable metal such as steel is located at the rearward side of flange 11. Screws 12A extend through flanges 11 and 12 and into cylinder 9 to secure together the components of carriage 8.

Flanges 11 and 12 both embrace mandrel 2 and are sidable therealong rearward of threaded portion 6. Cylinder section 10 is provided with internal threads 15 sized to mesh with the external threaded portion 6 when carriage 8 is moved forward along the mandrel and the mandrel rotated in counter-clockwise direction, looking from in front of mandrel 2.

A disc-shaped magnet 13 is mounted on an oilite bushing 14, which in turn is slidably mounted as a collar on mandrel 2 between steel flange 12 of carriage 8 and shank end 3 of mandrel 2. Shank end 3 has an externally threaded section 3A at its terminal end for receiving a retaining nut, as will be discussed later.

A router head 16 is mounted at the forward end of carriage 8 extending forward from cylinder section 9. Router head 16 has a pair of cutting bits 17 to provide an effective cutting diameter of 1 and ¼ inches. As with implement 4 router head 16 cuts primarily sideways of the mandrel. Bits 17 are also designed to cut in counter-clockwise rotation, looking from in front of mandrel 2.

Both implement 4 and router head 16 are specifically designed for operation at a limited depth and to mill moving primarily in the plane perpendicular to the rotational axis of the tool. They are thus particularly useful for milling hinge and latch pockets in doors.

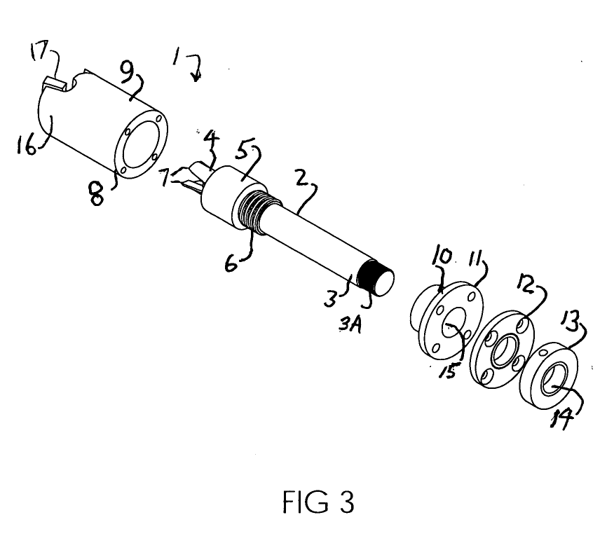

As can be seen in FIG. 1 through 3, when carriage 8 is in its rearward or retracted position, section 8 thereof is rearward of threaded portion of mandrel 2 and the respective threads of the mandrel and carriage are not engaged. At this retracted position implement 4 on mandrel 2 is in the active position forward of router head 16 and exposed for routing operations.

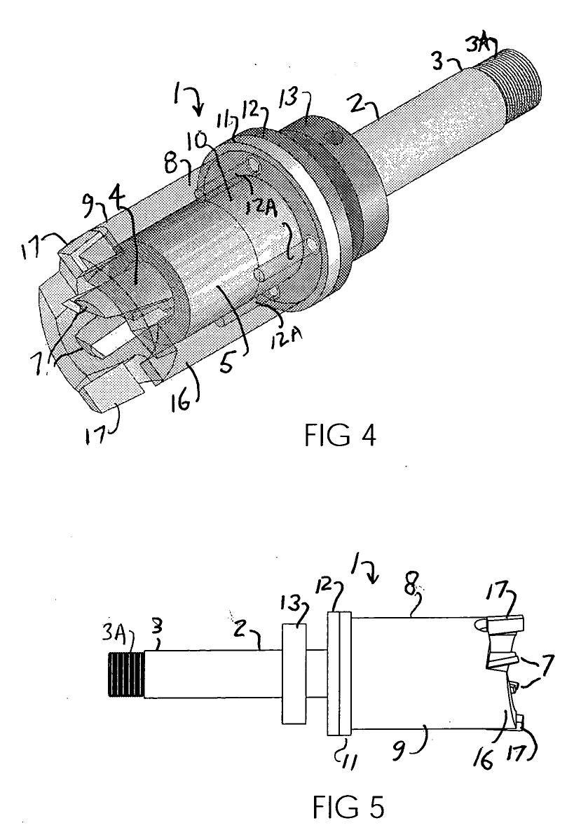

To move carriage 8 to its active position, it is first moved forward to bring cylinder 10 to the mandrel threaded portion 6. Then, by rotating the carriage in the clockwise direction, looking from in front of mandrel 2, threaded portion 6 may be engaged with threads 15 of section 10 and carriage 8 thus screwed forward along mandrel 2 to its forward active position as shown in FIGS. 4 and 5 with the forward end of cylinder section 10 lodged against the rear end of bushing 5. At this position implement 4 is fully retracted to within router head 16 and cylinder section 9. Thus, in this position, implement 4 is in the inactive position and router head 16 exposed for routing operations without interference by implement 4.

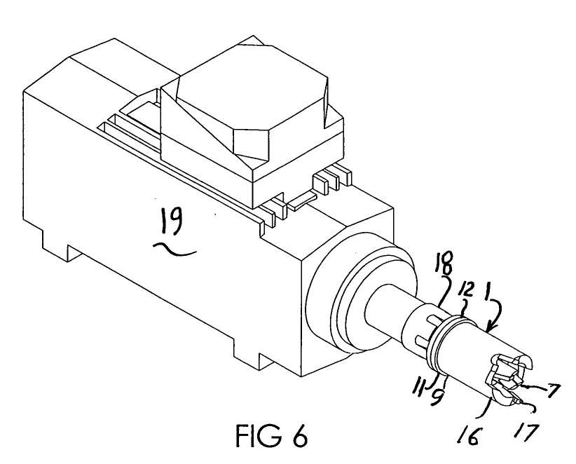

In use, as seen in FIG. 6, the shank end 3 of tool 1 is secured in the chuck 18 on the arbor of a motor 19 that is rotatable in the counter-clockwise direction, looking toward the motor arbor from in front of the chuck. Then, with carriage 8 at the forward position, the carriage may be rotated by hand in the clockwise direction looking from in front of mandrel 2 while holding mandrel 2 from rotation. This will screw carriage 8 backward along mandrel 2 until cylinder section 10 is behind threaded portion 6. From there carriage 8 may be pulled freely by hand fully back to the retracted position. As seen in FIG. 6, with carriage 8 at the retracted position, magnet 21 will hold against carriage 8 on one (forward) side and against the chuck on the motor on the other (rearward) side, thus preventing carriage 8 from moving forward during use of implement 4.

When it is then desired to switch back to router head 16, the procedure is reversed, Carriage 8 is pulled forward by hand, overcoming the magnet force, up to threaded portion 6 of mandrel 2. Then carriage 8 is rotated by hand, while holding mandrel 2 from turning. This will engage the threads of threaded portion 6 with the threads of internal threads 15 of inner cylinder section 10 to screw carriage 8 forward along mandrel 2, until the front end of cylinder 10 lodges against the back end of bushing 5. Bushing 5 acts as an interlocking device by stopping further forward movement of carriage 8 and stopping relative rotation between of carriage 8 about mandrel 2 when mandrel 2 continues to rotate at that position.

The foregoing binary tool may also be modified for use with a motor that is rotatable only in the clockwise direction, looking toward the motor arbor from in front of the chuck, as follows. The left-handed threads of externally threaded portion 6 of mandrel 2 are replaced with right-handed threads. This will cause carriage 8 to be screwed forward by the clockwise rotation of the motor and thus of mandrel 2 and hold router head 16 at the active position. The implements employed will need to be those operable upon clockwise rotation, e.g. with cutter blades designed for operation in clockwise rotation.

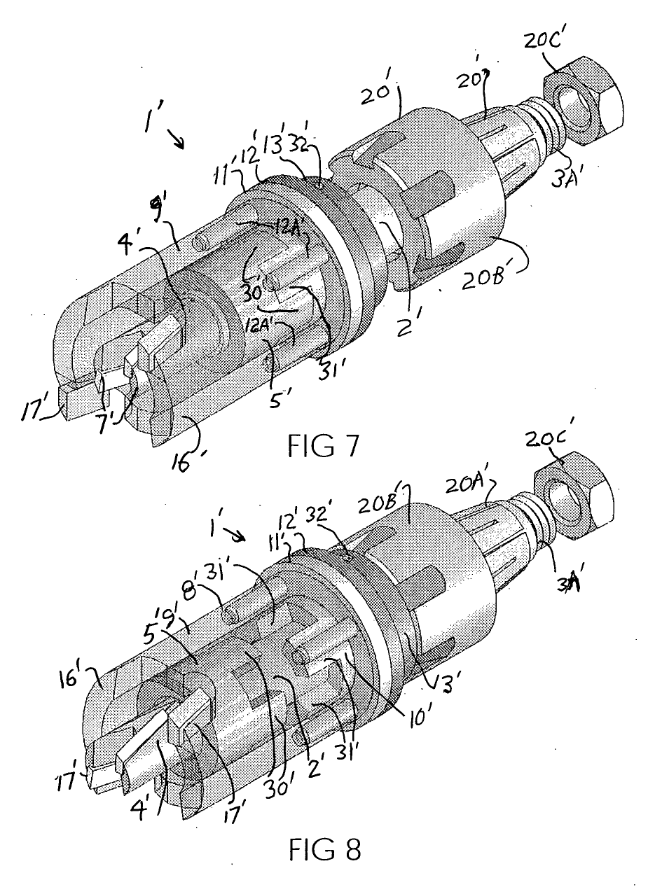

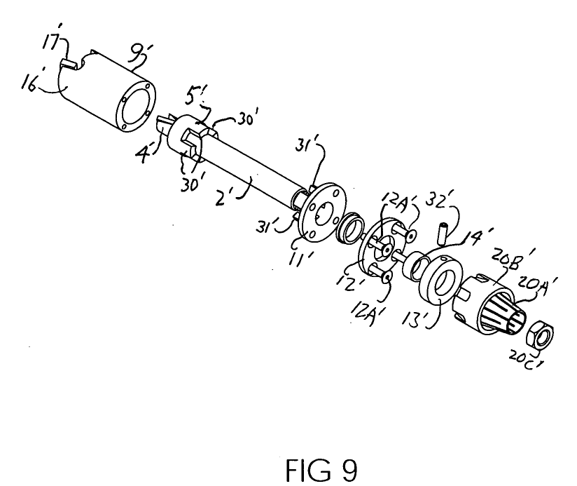

Another embodiment of the invention is illustrated in FIGS. 7, 8 and 9. The tool of this embodiment may be operated by a motor having either clockwise or counter-clockwise rotation, with selection of implements operating in the rotational direction of the motor. In this embodiment with the following noted differences, the tool construction is the same as described in the embodiment of FIGS. 1 to 6, with corresponding elements having the same reference numbers as found for that embodiment except that the numbers are primed.

In this embodiment mandrel 2′ has no threaded portion. Instead, over its entire length mandrel 2′ has a smooth surface. Similarly, inner cylinder section 10′ has no internal threads 15 and its central opening is simply in sidable contact with mandrel 2′. In this embodiment elements are provided on the mandrel and on the carriage that interlock when the carriage is at the forward position to prevent relative rotation between the mandrel and the carriage.

Specifically, at its rearward end bushing 5′ has locking lugs 30′. At its forward end inner cylinder section 10′ has locking lugs 31′ that are engagable with lugs 30′ when carriage 8′ is moved forward and rotated to mating position.

Additionally, a releasable retainer operable to selectively retain the carriage at the forward position is provided for this embodiment. For this magnet 13′ is provided with a set screw 32′ that may be used to selectively fix its position along mandrel 2′. Thus, magnet 13′ may be fixed by set screw 32′ immediately behind carriage 8′, when it is at the forward position, to maintain it there. Also, magnet 13′ may be fixed by set screw at a rearward location near the shank end of mandrel 2′ so that carriage 8′ rather than allowing it float along mandrel 2′ when carriage 8′ moves to the rearward position. This may more securely fix carriage 8′ at its rearward position. A set screw may be employed similarly in other embodiments, such as that of FIGS. 1 to 6, to fix the magnet more firmly at the rearward position.

A collet 20′ is fixed on shank end 3′ of mandrel 2′ comprising a collet body 20A′ and ring nut 20B′ for compressing body 20A′ against shank end 3′. A retainer nut 20C′ is screwed onto shank end 3′ collet 20′ from slipping rearward off of shank end 3′.

Operation of tool 1′ is as follows. To bring router head 16′ from the inactive to the active position, carriage 8′ is slid forward manually until cylinder section 10′ and bushing 5′ are adjacent. Carriage 8′ is then rotated by hand to bring lugs 30′ into an orientation that they will mate with lugs 31′. Carriage 8′ is then pushed further forward to mate lugs 30′ with lugs 31′ and thereby lock carriage 8′ from rotating relative to mandrel 2′. Then set screw 32′ is set to prevent axial movement between carriage 8′ and mandrel 2′. By this interlocking, router head 16′ will turn with mandrel 2′ for routing and carriage 8′ will remain at the forward position during use of router head 16′.

To move router head 16′ from the active to the inactive position, (and thus implement 4′ from the inactive to the active position), set screw 32 is first released and carriage 8′ pulled manually back to its rearmost position adjacent the chuck of the motor. There, float magnet 13′ hold against carriage 8′ on its forward side and against the chuck on the motor (not shown) on its rearward side, thus preventing carriage 8 from moving forward during use of implement 4.

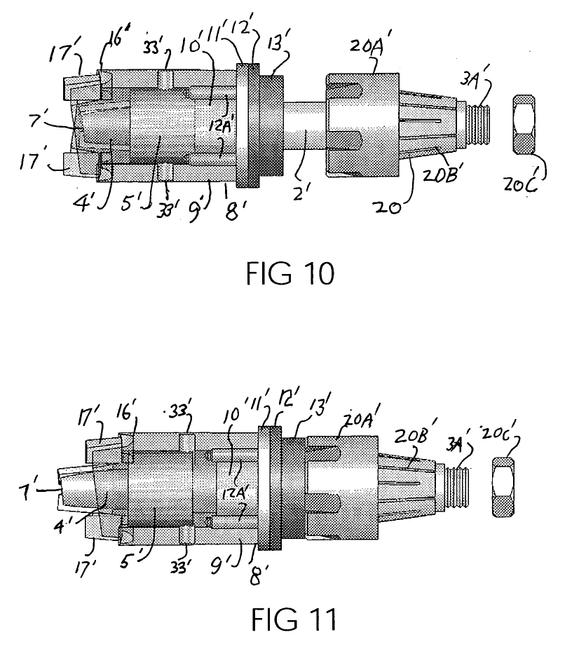

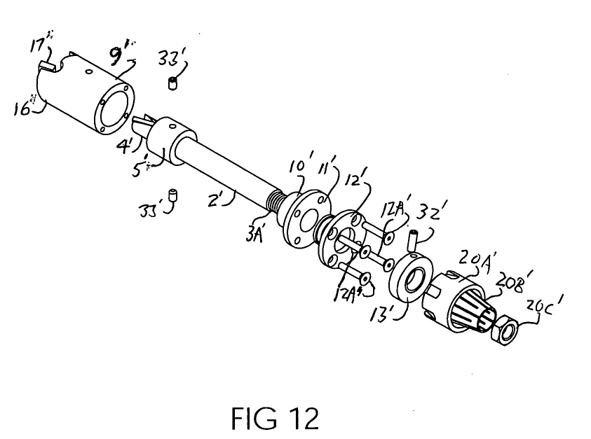

As illustrated in FIGS. 10 through 12, various other expedients may be employed to lock carriage 8′ at the forward position and from rotating relative to mandrel 2′ when at that position. In this example at their abutting ends bushing 5′ has no lugs 30′ and inner cylinder section 10′ no lugs 31′. Instead, as an interlock, a capped, threaded pin 33′ at either side of carriage 8′ may be inserted through an opening 34′ in outer cylindrical section 9′ and into a threaded hole tapped in bushing 5′ in register with opening 34′ when carriage 8′ is at the forward position. Pins 34′ may thus be inserted when it is desired to use router head 16′ with carriage 8′ at the forward position. Pins 33′ are then removed when it is desired to move carriage 8′ to the rearward position.

Tools such as the tools with routing implements as described above may be for use at very high revolutions per minute of rotation. For safety it is important that such tools have a good weight balance around the axis of rotation so as to avoid dangerous vibration due to unbalanced centrifugal forces.

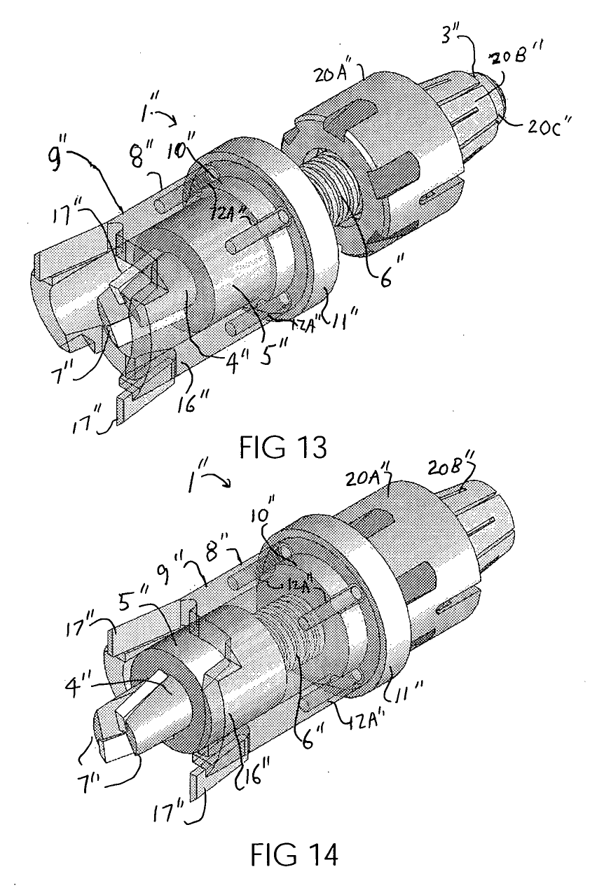

A motor capable of both clockwise and counter-clockwise rotation may be employed for all of the foregoing embodiments, with the selection of the appropriate direction of rotation. Additionally, these motors may be employed with special embodiments of the invention which are capable of essentially automatic changeover of implements. Such an embodiment is shown in FIGS. 13 through 16, with corresponding elements having the same reference numbers as found in the embodiment of FIGS. 1 through 6, except that the numbers are double primed. This tool construction is the same as described in the embodiment of FIGS. 1 through 6 except for the following noted differences, The threaded portion 6″ of mandrel 2″ extends the full length thereof. The magnet 13 and steel flange 12 are omitted and flange 11″ is provided with internal threads as a continuation of the internal thread of inner cylindrical section 10″.

In the present embodiment such threads may be either left or right handed but implements requiring a specific rotation direction must be chosen as appropriate to the rotation direction resulting from choice of this thread orientation. The threads chosen for this example are right handed. With this orientation implement 4″ is then rotated by mandrel 2″ in the counter clockwise direction, looking from in front of implement. This is preferred because commercial router heads such as implement 4″ with such counterclockwise directionality are easily available. The motor rotation direction will be reversed for bringing carriage 8″ to the forward position and carriage 8″ will accordingly drive implement 16″ in the opposite rotational direction (clockwise). Thus implement 16″ must be designed to operate while being rotated in a clockwise direction, looking from in front of implement.

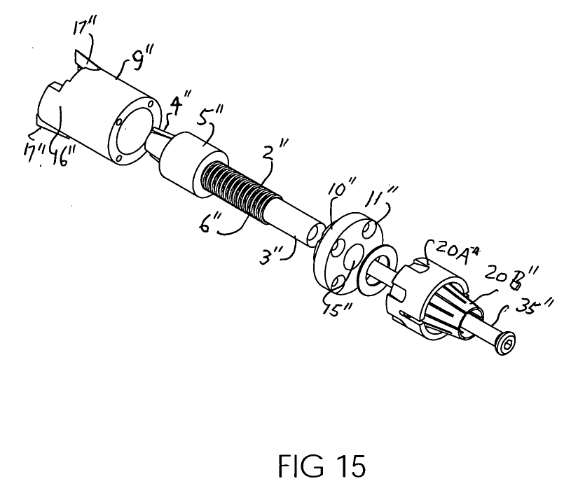

Referring to FIG. 15, it will be noted that mandrel 2″ is tubular and have a bolt 35″ extending internally the length of mandrel 2″ to screw into the rear end of implement 4 to secure it in place at the forward end of mandrel 2. This arrangement may also be used in all the other embodiments in order to make it easier to change implements on the mandrel.

Operation of tool 1″ is as follows. To move carriage 8″ with router head 16″ from the inactive to the active position, mandrel 2″ is rotated in the clockwise direction, looking from in front of the mandrel. If the friction between mandrel 2″ is sufficiently low and the inertia of carriage 8″ is sufficiently high, carriage 8′ will be screwed along mandrel 2″ to the forward active position. If the friction is too high or the inertia of carriage 8″ too low, frictional drag may be applied to carriage 8″ to overcome friction, as will be described below. At the active position mandrel 2″ and carriage 8″ are interlocked as described for the embodiment of FIGS. 1 through 6 and router head 16″ will turn with mandrel 2″ for routing.

To move router head 16″ from the active to the inactive position, (and thus implement 4″ from the inactive to the active position), mandrel 2″ is rotated in the counterclockwise direction, looking from in front of the mandrel. Carriage 8″, with the application of frictional drag, if necessary, will be screwed along mandrel 2″ to reach collet 20″. Collet 20″ thus acts as an interlocking device by stopping further rearward movement of carriage 8″ and stopping counter-clockwise rotation of carriage 8″ about mandrel 2″ when at that position. At that position implement 4″ is in the active position for milling by counterclockwise rotation, looking from in front of implement.

However, inertia may not be enough to move carriage 8″ from one end of its path to the other. This may be due to sticking at one end or the other or too much friction along the way. To remedy this rotation of carriage 8″ may be restrained by hand, applying friction to it during rotation of mandrel 2″ to move carriage 8″ between the forward and rearward positions. Preferably, both for convenience and safety, friction may be applied automatically to carriage 8″ for this purpose as follows.

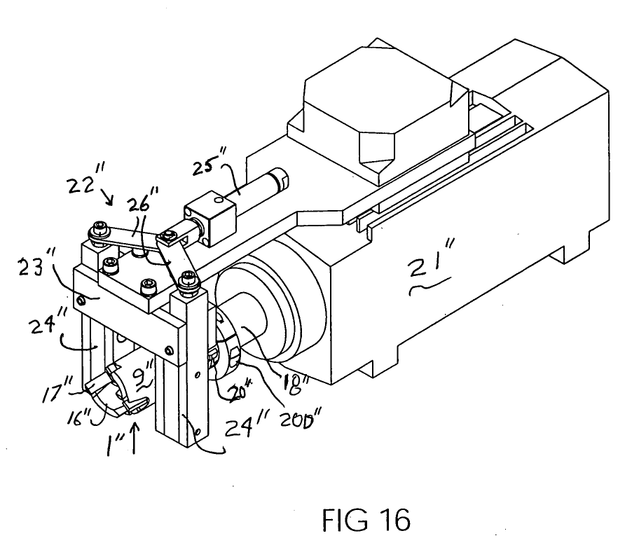

As seen in FIG. 16, tool 1″ may be mounted by securing the shank end portion 3″ bearing collet 20″ in the chuck 18″ of a two-way rotational motor 21″. A compression ring 20D″ is mounted around the retainer ring of collet 20″ engaged in chuck 18″ as a safety measure in view of the high revolutions per minute employed in routing operations. Mounted on motor 21″ is a braking system 22″ comprising a frame 23″ supporting a pair of brake shoes 24″ straddling carriage 8″ of tool 1″ mounted on the motor and an actuator system comprising a piston 25″ acting through toggle arms 26″ to open and close brake shoes 24″ against carriage 8″.

When motor 21″ is being operated to move carriage 8″ between the forward and rearward positions, arms 26″ may actuated by piston 25″, to press brake shoes 24″ against carriage 8″. This prevents carriage 8″ from rotating but still permits it to move in the axial direction by the screw action. Braking system 22″ may be operated for a short time upon each change of rotational direction for switching heads to insure that carriage 8″ is screwed to the other end of its path.

1. A tool for carrying out a plurality of mechanical functions which comprises:
a. a mandrel for supporting for rotation a first implement at a forward axial end thereof,
b. a first tool implement mounted at the forward axial end of the mandrel capable of carrying out a desired mechanical function by rotation thereof at the forward axial end of the mandrel,
c. a carriage borne by the mandrel that is rotatable about the same axis as the mandrel and that has a forward end in the axial direction of the forward end of the mandrel,
d. a second tool implement mounted at the forward end of the carriage capable of carrying out a desired mechanical function by rotation thereof at the forward end of the carriage; and
wherein the carriage is selective moveable in the axial direction of the mandrel between a rearward position, with the first tool implement at an advanced active location for carrying out its mechanical function and the first implement is in a rearward inactive location, and a forward position, with the second implement at an advanced active location for carrying out its mechanical function and the first implement at a rearward inactive location, and the carriage, when at the forward position, being capable of rotated by the mandrel about the axis of the mandrel, thereby to rotate the second tool implement at forward end thereof.

2. A tool as in claim 1 and wherein an interlock device is provided on the tool that releasably holds the carriage at the forward position and stops relative rotational movement between the mandrel and the carriage while the carriage is at the forward position, thereby permitting the carriage to be driven by the mandrel when the carriage is at the forward position.

3. A tool as in claim 2 and wherein the interlocking device comprises removable elements for fixing the carriage to the mandrel.

4. A tool as in claim 3 and wherein the removable elements comprise removable pins extending through the carriage and into the mandrel.

5. A tool as in claim 3 and wherein the interlocking device comprises elements on the mandrel and on the carriage that interlock when the carriage is at the forward position to prevent relative rotation between the mandrel and the carriage and a releasable retainer operable to selectively retain the carriage at the forward position.

6. A tool as in claim 3 and further including a detent selectively operable when the carriage has moved to the rearward position to releasably restrain the carriage from movement forward of the rearward position.

7. A tool as in claim 6 and wherein the detent comprises a magnet located behind the rearward position of the mandrel.

8. A tool as in claim 1 and wherein the first tool implement has an axis of rotation about which the first implement may be rotated to carry out its desired mechanical function, the first implement being mounted at the forward end of the mandrel with the axis of rotation of the first implement coaxial with the mandrel axis of rotation and the second tool implement has an axis of rotation about which the second implement may be rotated to carry out its desired mechanical function, the second implement being mounted at the forward end of the carriage with the axis of rotation of the second implement coaxial with the carriage axis of rotation.

9. A tool as in claim 8 and wherein the first and second tool implements are both routing implements.

10. A tool as in claim 1 and wherein the carriage has an internally threaded portion, the mandrel has a threaded portion at the periphery extending along the axial direction thereof forward on the mandrel from an intermediate point between the rearward and forward positions of the carriage and the mandrel is received by the carriage threaded section with the threads of the mandrel meshed with the threads of the threaded portion of the carriage so that, upon movement of the carriage forward from the rearward position until the threaded portion of the carriage reaches the mandrel screw threads the threads will be engaged by rotation of the mandrel relative to the carriage in the appropriate rotational direction and the carriage screwed to the forward position.

11. A tool for carrying out a plurality of mechanical functions which comprises:
a. a mandrel for supporting for rotation a first implement at a forward axial end thereof,
b. first tool implement mounted at the forward axial end of the mandrel capable of carrying out a desired mechanical function by rotation thereof at the forward axial end of the mandrel,
c. a carriage borne by the mandrel that is rotatable about the same axis as the mandrel and that has a forward end in the axial direction of the forward end of the mandrel,
d. a second tool implement mounted at the forward end of the carriage capable of carrying out a desired mechanical function by rotation thereof at the forward end of the carriage; and
wherein the carriage is selective moveable in the axial direction of the mandrel between a rearward position, with the first tool implement at an advanced active location for carrying out its mechanical function and the first implement is in a rearward inactive location, and a forward position, with the second implement at an advanced active location for carrying out its mechanical function and the first implement at a rearward inactive location, and the carriage, when at the forward position, being capable of rotated by the mandrel about the axis of the mandrel, thereby to rotate the second tool implement at forward end thereof and wherein the carriage has an internally threaded portion, the mandrel has threaded portion at the periphery extending along the axial direction thereof forward on the mandrel from an intermediate point between the rearward and forward positions of the carriage and the mandrel is received by the carriage threaded section with the threads of the mandrel meshed with the threads of the threaded portion of the carriage so that, upon movement of the carriage forward from the rearward position until the threaded portion of the carriage reaches the mandrel screw threads the threads will be engaged by rotation of the mandrel relative to the carriage in the appropriate rotational direction and the carriage screwed to the forward position.

12. A tool as in claim 11 and wherein the tool has an interlocking device to lock the carriage to the mandrel at the forward position so the mandrel will rotate the carriage, and thereby the second tool implement, comprising: a stop, operative when the mandrel is rotated in the direction for moving the carriage to the forward position, to stop the carriage at the forward position and, acting together with the meshed threads of the carriage and mandrel, to stop axial rotation of the carriage relative to the mandrel when the mandrel continues to rotate in the forward position for rotating the second implement.

13. A tool as in claim 12 and further including a detent selectively operable when the carriage has moved to the rearward position to releasably restrain the carriage from movement forward of the rearward position.

14. A tool as in claim 12 and wherein the detent comprises a magnet located behind the rearward position of the mandrel.

15. A tool as in claim 12 and wherein the first and second implements are both routing implements.

16. A tool for carrying out a plurality of mechanical functions which comprises:
a. a mandrel for supporting for rotation about its axis a first tool implement at forward axial end thereof, the mandrel having screw threads at the periphery extending along the axial direction thereof
b. a first tool implement mounted at the forward axial end of the mandrel capable of carrying out a desired mechanical function by rotation thereof at the forward axial end of the mandrel,
c. a carriage borne by the mandrel axially outward of the mandrel, the carriage extending to a forward end in the direction of the mandrel forward end and having a screw threaded portion,
d. a second tool implement mounted at the forward end of the carriage capable of carrying out a desired mechanical function by rotation thereof at the forward end of the carriage; and
wherein the mandrel is received by the carriage with the threads of the mandrel meshed with the threads of the threaded portion of the carriage so that, upon rotation of the mandrel relative to the carriage in the appropriate rotational direction, the carriage may be selectively moved along the mandrel threads in either axial direction, between a rearward position with the first tool implement axially forward of the second tool implement, whereby the first implement is in the active position for carrying out its mechanical function and the first implement is not and a forward position with the second tool implement forward of the first tool implement, whereby the second implement is in position for carrying out its mechanical function and the first implement is not.

17. A tool as in claim 16 and wherein the tool has an interlocking device to lock the carriage to the mandrel at the forward position so the mandrel will rotate the carriage, and thereby the second tool implement, comprising: a stop, operative when the mandrel is rotated in the direction for moving the carriage to the forward position, to stop the carriage at the forward position and, acting together with the meshed threads of the carriage and mandrel, to stop axial rotation of the carriage relative to the mandrel when the mandrel continues to rotate in the forward position for rotating the second implement.

18. A tool as in claim 16 and wherein the first and second implements are both routing implements.

19. A tool as in claim 16 and wherein the mandrel threads are left hand and the first implement is capable of operating in the counterclockwise direction, looking from in front of the implement, and the direction for operating the direction for operating the second implement is capable of operating in the clockwise direction, looking from in front of the implement.

20. A tool as in claim 16 and further including a motor having an arbor for rotation, the motor capable of selectively rotating in the clockwise and counterclockwise directions, the tool being mounted for rotating the mandrel in a clockwise or counterclockwise direction, as selected, to thereby move the carriage between the active and inactive positions for using the second or first tool implement, respectively.

21. A tool as in claim 20 and further including a brake selectively operable against the carriage to slow rotational movement thereof as the mandrel is rotated, thereby to facilitate movement of the carriage in the axial direction between the inoperative and operative positions.
